(19) United States
(12) Patent Application Publication
(10) Pub. No.: US 2007/0266809 A1
(43) Pub. Date: Nov. 22, 2007

(54) Lift actuator and lift machine incorporating same

(76) Inventor: Detlev Ziesel, Lake Orion, MI (US)

Correspondence Address: WOOD, HERRON & EVANS, LLP, 2700 CAREW TOWER, 441 VINE STREET, CINCINNATI, OH, 45202, US

(21) Appl. No.: 11/436,791

(22) Filed: May 18, 2006

(51) Int. Cl. F16H 31/00

(52) U.S. Cl. 74/127

(57) ABSTRACT

A lift actuator comprises a sun screw having a longitudinal axis and being restrained from rotation about the longitudinal axis of the sun screw, at least one planetary screw having a longitudinal axis and being in thread engagement with the sun screw, and a drive nut having a longitudinal axis coincident with the longitudinal axis of the sun screw and being in thread engagement with the planetary screw. The drive nut is mounted for rotation about the longitudinal axis of the drive nut but is restrained from translation along the longitudinal axis of the drive nut. When the drive nut is rotated by a rotational energy source, the drive nut drives the planetary screw to rotate and thereby translate axially relative to the drive nut, and the rotating planetary screw in turn causes the sun screw to translate axially relative to the rotating planetary screw.

### FIELD

This invention relates generally to lift machines and to lift actuators for lift machines, and more particularly to lift machines for use in the automotive vehicle manufacturing industry for lifting a vehicle chassis into place underneath a suspended vehicle body for subsequent fastening of the chassis to the body and to lift actuators for such lift machines.

### BACKGROUND

In the automotive vehicle manufacturing industry, it is customary to “marry” the vehicle chassis to the vehicle body on a moving conveyer line. The body is typically conveyed overhead by a conveyor, and the chassis to be married to the body is supported by a moving lift machine that operates to move the chassis into position beneath the moving body while lifting the chassis into position for assembly with the body.

Lift machines may employ different lift actuators to raise and lower the platform or support upon which the vehicle chassis is supported. For example, a hydraulic cylinder can be used as the lift actuator. U.S. Pat. No. 6,109,424, hereby incorporated by reference herein, discloses the use of a push chain as the lift actuator. And, U.S. Patent Application Publication No. US 2004/0007440 A1, also hereby incorporated by reference herein, discloses the use of a spiral lift as the lift actuator.

It is desirable to improve upon the aforementioned lift actuators and lift machines.

### SUMMARY

In one aspect, a lift actuator comprises a sun screw having a longitudinal axis and being restrained from rotation about the longitudinal axis of the sun screw, at least one planetary screw having a longitudinal axis and being in thread engagement with the sun screw, and a drive nut having a longitudinal axis coincident with the longitudinal axis of the sun screw and being in thread engagement with the planetary screw. The drive nut is mounted for rotation about the longitudinal axis of the drive nut but is restrained from translation along the longitudinal axis of the drive nut. When the drive nut is rotated by a rotational energy source, the drive nut drives the planetary screw to rotate and thereby translate axially relative to the drive nut, and the rotating planetary screw in turn causes the sun screw to translate axially relative to the rotating planetary screw.

The lift actuator can comprise three planetary screws. The three planetary screws can be positioned such that the longitudinal axes of the planetary screws are parallel to, on a common radius extending from, and equally spaced about, the longitudinal axis of the sun screw. The lift actuator can further include a timing mechanism associated with the drive nut for maintaining timing between the drive nut and the planet screws. A cylinder can be mounted to a lower end of the drive nut, and the timing mechanism can be mounted to the cylinder. A drive pulley can be mounted to the cylinder. The timing mechanism can be a planetary gear on a lower end of each of the planetary screws, and a ring gear associated with the drive nut, the planetary gears being in thread engagement with the ring gear.

In another aspect, a lift machine comprises a base, a lift platform, and the aforementioned lift actuator mounted between the base and the lift platform.

### DRAWINGS

FIG. 1 is a side view of a lift machine and lift actuator of the present invention,

FIG. 2A is an enlarged partial cross-sectional view of the lift actuator of FIG. 1 shown in a retracted position,

FIG. 2B is a view similar to FIG. 2 but of the actuator in an extended position,

FIG. 3 is a view of the lower end of the actuator in the FIG. 2B position, but shown in perspective from below,

FIG. 4 is a view taken along line 4-4 in FIG. 2A,

FIG. 5 is a view taken along line 5-5 in FIG. 2A, and

FIG. 6 is an exploded perspective view of the upper end of the actuator of FIGS. 1-5.

### DESCRIPTION

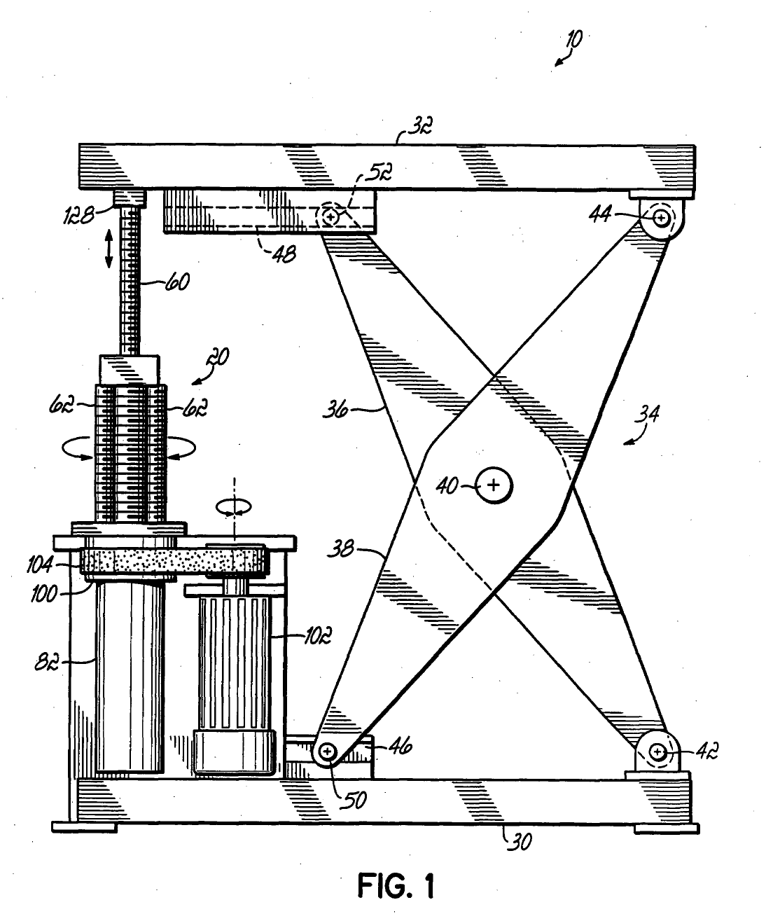

Referring first to FIG. 1 there is illustrated a lift machine 10 including a lift actuator 20 according to the present invention. Lift machine 10 can include a base 30 and a lift platform 32 supported above the base 30 by a linkage such as a scissors linkage 34. Scissors linkage 34 can include a pair of scissors links 36, 38 pivoted at their mid points 40. The lower end of link 36 and the upper end of link 38 can be pivoted to the base 30 and lift platform 32, respectively at pivots 42, 44, respectively. The lower end of link 38 and the upper end of link 36 can be mounted for rolling movement in tracks 46, 48, respectively of base 30 and lift platform 32, respectively, via rollers 50, 52.

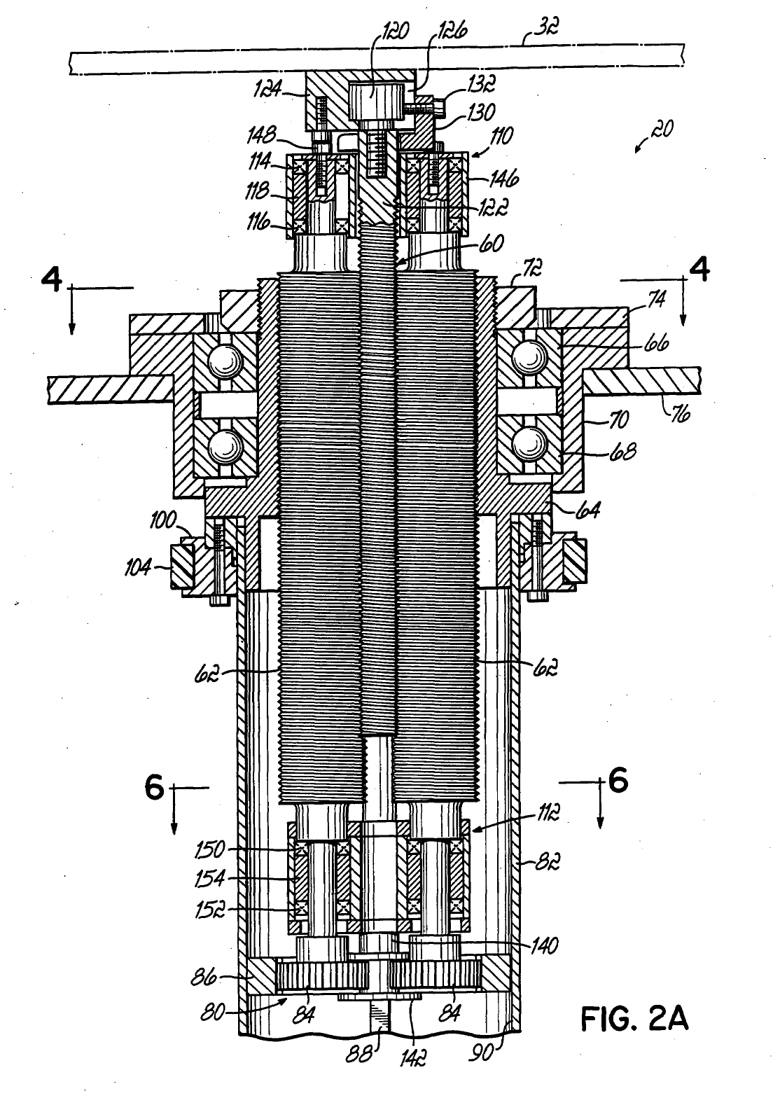

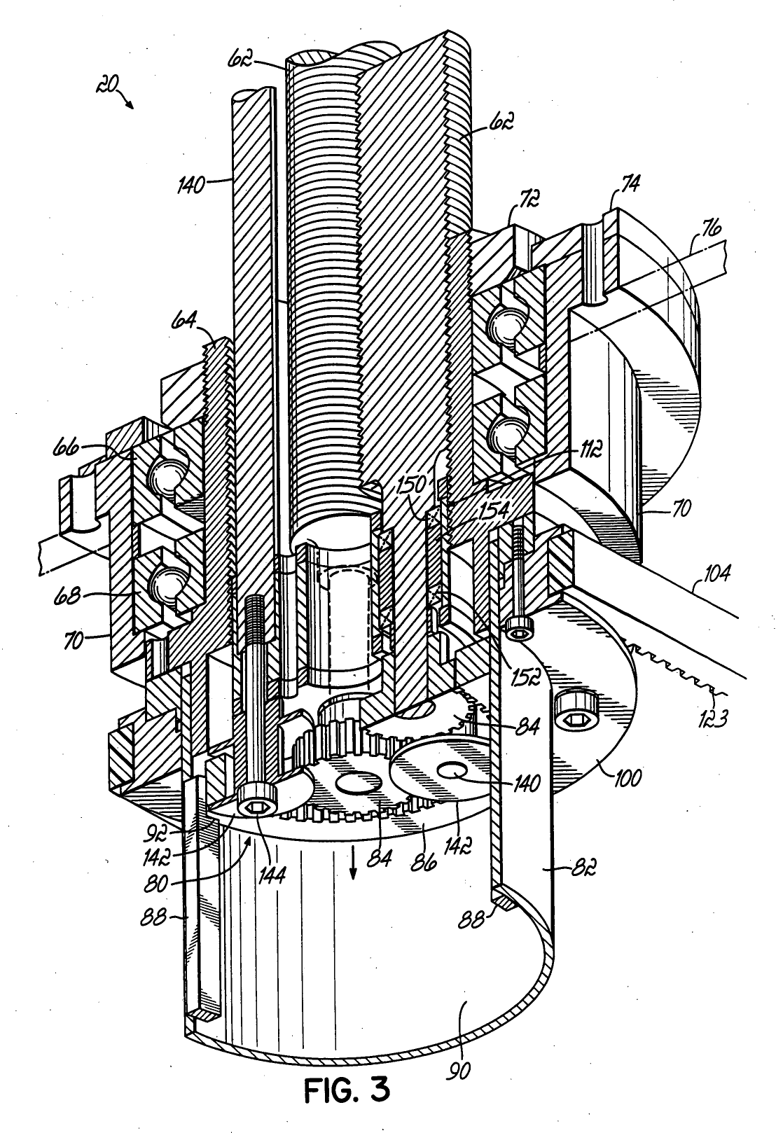

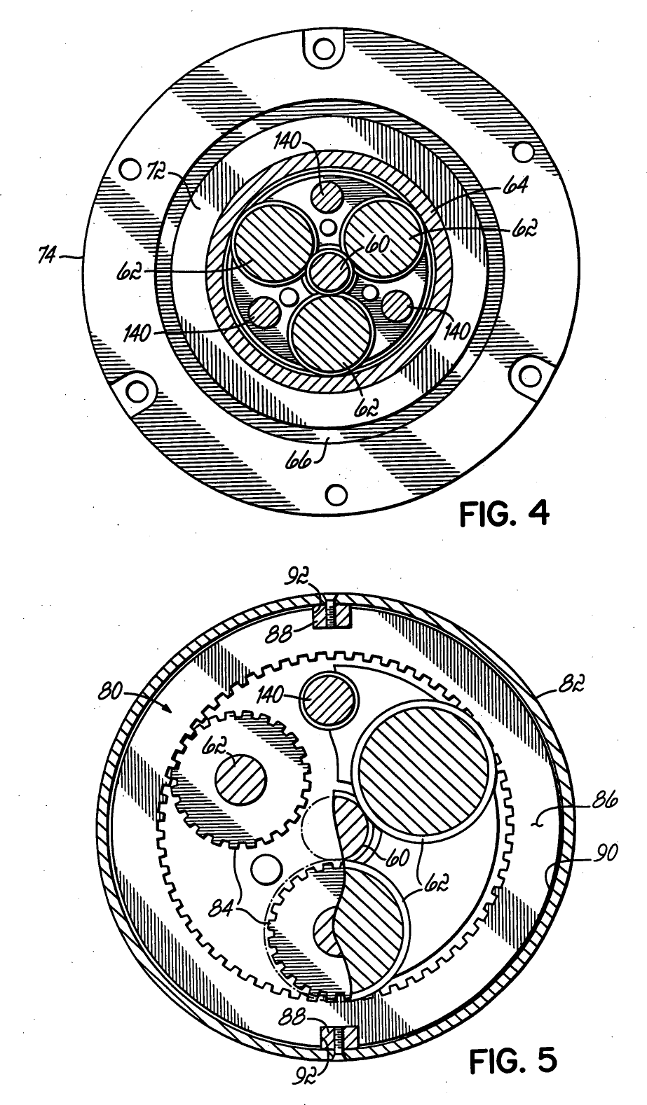

Referring now to FIGS. 2-6, the lift actuator 20 is shown in more detail. More particularly, lift actuator 20 has a sun screw 60 having a longitudinal axis. Sun screw 60 is restrained from rotation about its longitudinal axis, in a manner to be described below. At least one planetary screw 62 has a longitudinal axis and is in thread engagement with the sun screw 60. For example, lift actuator 20 can have three such planetary screws 62 positioned such that the longitudinal axes of the three planetary screws 62 are parallel to, on a common radius extending from, and equally spaced about, the longitudinal axis of the sun screw 60. A drive nut 64, for example a ten start thread drive nut, has a longitudinal axis coincident with the longitudinal axis of the sun screw 60 and is in thread engagement with the planetary screws 62. The drive nut 64 is mounted for rotation about its longitudinal axis but is restrained from translation along its longitudinal axis. For example, drive nut 64 can be mounted in a pair of radial bearings, an upper bearing 66 and a lower bearing 68. Bearings 66, 68 can be mounted in a hub 70. A lock nut 72 can secure the inner races of bearings 66, 68 to drive nut 64, and a locking ring 74 can secure the outer races of bearings 66, 68 to hub 70. Hub 70 can be mounted to a plate 76 which can be mounted to, or otherwise form a part of, base 30. Rotation of drive nut 64 by a rotational energy source, to be described below, drives the planetary screws 62 to rotate and thereby translate axially relative to the drive nut 64. The rotating planetary screws 62 in turn cause the sun screw 60 to translate axially relative to the rotating planetary screws 62 thereby raising and lowering platform 32.

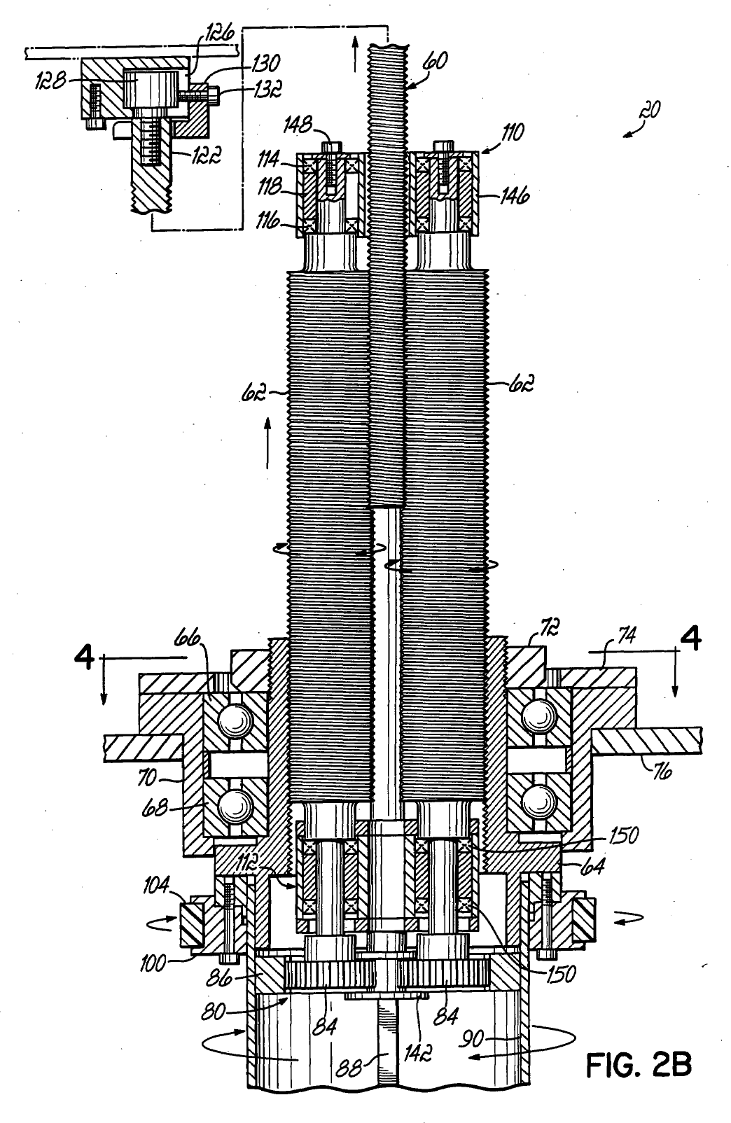

A timing mechanism 80 can be included for maintaining timing between the drive nut 64 and the planetary screws 62. A cylinder 82 can be mounted to a lower end of the drive nut 64. The timing mechanism 80 can be mounted to the cylinder 82. The timing mechanism 80 can include a planetary gear 84 on a lower end of each planetary screw 62, and a ring gear 86 mounted to the cylinder 82, or otherwise associated with the drive nut 64, in thread engagement with the planetary gears 84. Ring gear 86 can be splined to cylinder 82 via longitudinal guides 88 secured to the inner wall 90 of the cylinder 82 in sliding engagement with notches 92 in ring gear 86 (FIG. 3).

A pulley 100 can be operably mounted to drive nut 64 so that a rotational energy source, for example electric motor 102, can drive drive nut 64 via a belt 104.

The upper and lower ends of the planetary screws 62 can be rotatably supported in upper and lower bearing assemblies 110, 112, respectively. Upper bearing assembly 110 includes upper and lower thrust bearings 114, 116, respectively for each planetary screw 62 and a radial bearing 118 interposed between each set of upper and lower thrust bearings 114, 116, respectively. Similarly, lower bearing assembly 112 includes upper and lower thrust bearings 150, 152, respectively for each planetary screw 62 and a radial bearing 154 interposed between each set of upper and lower thrust bearings 150, 152, respectively.

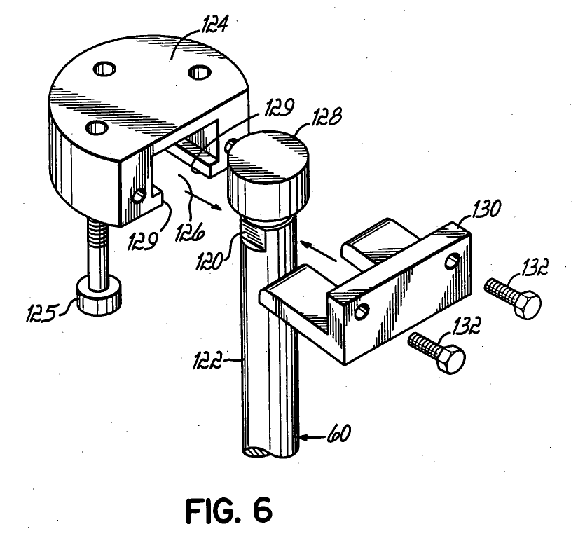

Referring to FIG. 6, upper end of sun screw 60 can include flats 120 machined into opposite sides of the shaft 122 of the sun screw 60. A mounting block 124 can be provided which mounts to an underside of lift platform 32 with fasteners 125. Block 124 can have a recess 126 for accommodating head 128 of screw shaft 122. Sides 129 of recess 126 cooperate with flats 120 on screw shaft 122 to prevent rotation of sun screw 60 once installed in block 124. A bracket 130 can then be secured to block 124 with fasteners 132 to secure shaft head 128 in block 124.

Finally, to secure the entire assembly together end-to-end, three connecting rods or spacer bars 140 can be provided. Each spacer bar 140 can be provided with an idler gear 142 secured on a lower end thereof with a screw 144. The upper ends of spacer bars 140 are secured to a bearing housing 146, housing upper bearing assembly 110, with screws 148.

The embodiments of the invention shown and described are for illustrative purposes only. The drawings and the description shall not limit in any way the scope of the invention as defined in the claims. While those skilled in the art may make various changes to, or additional embodiments of, the invention, none of those changes/embodiments shall be deemed to depart from the spirit of the invention. Thus, all such changes/embodiments shall be embraced by the scope of the invention as defined in the claims. Accordingly, the invention is to be limited only by the scope of the following claims and their equivalents.

1. A lift actuator comprising:
a sun screw having a longitudinal axis and being restrained from rotation about the longitudinal axis of said sun screw,
at least one planetary screw having a longitudinal axis and being in thread engagement with said sun screw, and
a drive nut having a longitudinal axis coincident with the longitudinal axis of said sun screw and being in thread engagement with said at least one planetary screw, said drive nut being mounted for rotation about the longitudinal axis of said drive nut but restrained from translation along the longitudinal axis of said drive nut,
whereupon when said drive nut is rotated by a rotational energy source said drive nut drives said at least one planetary screw to rotate and thereby translate axially relative to said drive nut, and said rotating planetary screw in turn causes said sun screw to translate axially relative to said rotating planetary screw.

2. The lift actuator of claim 1 comprising three said planetary screws.

3. The lift actuator of claim 2 wherein said three planetary screws are positioned such that the longitudinal axes of said three planetary screws are parallel to, on a common radius extending from, and equally spaced about, the longitudinal axis of said sun screw.

4. The lift actuator of claim 1 further including a timing mechanism associated with said drive nut for maintaining timing between said drive nut and said at least one planet screw.

5. The lift actuator of claim 4 comprising three said planetary screws, said three planetary screws being positioned such that the longitudinal axes of said three planetary screws are parallel to, on a common radius extending from, and equally spaced about, the longitudinal axis of sun screw.

6. The lift actuator of claim 5 further including a cylinder mounted to a lower end of said drive nut, said timing mechanism mounted to said cylinder.

7. The lift actuator of claim 6 further including a drive pulley mounted to said cylinder.

8. The lift actuator of claim 5 wherein said timing mechanism comprises:
a planetary gear on a lower end of each said planetary screw, and
a ring gear associated with said drive nut, said planetary gears being in thread engagement with said ring gear.

9. A lift machine comprising:
a base,
a lift actuator comprising:
a sun screw having a longitudinal axis and being restrained from rotation about the longitudinal axis of said sun screw,
at least one planetary screw having a longitudinal axis and being in thread engagement with said sun screw, and
a drive nut having a longitudinal axis coincident with the longitudinal axis of said sun screw and being in thread engagement with said at least one planetary screw, said drive nut being mounted for rotation about the longitudinal axis of said drive nut but restrained from translation along the longitudinal axis of said drive nut,
whereupon when said drive nut is rotated by a rotational energy source said drive nut drives said at least one planetary screw to rotate and thereby translate axially relative to said drive nut, and said rotating planetary screw in turn causes said sun screw to translate axially relative to said rotating planetary screw, and
a lift platform on an upper end of said sun screw.

10. The lift machine of claim 9 wherein the lift actuator comprises three said planetary screws.

11. The lift machine of claim 10 wherein said three planetary screws are positioned such that the longitudinal axes of said three planetary screws are parallel to, on a common radius extending from, and equally spaced about, the longitudinal axis of said sun screw.

12. The lift machine of claim 9 further including a timing mechanism associated with said drive nut for maintaining timing between said drive nut and said at least one planet screw.

13. The lift machine of claim 12 comprising three said planetary screws, said three planetary screws being positioned such that the longitudinal axes of said three planetary screws are parallel to, on a common radius extending from, and equally spaced about, the longitudinal axis of sun screw.

14. The lift actuator of claim 13 further including a cylinder mounted to a lower end of said drive nut, said timing mechanism mounted to said cylinder.

15. The lift actuator of claim 14 further including a drive pulley mounted to said cylinder.

16. The lift actuator of claim 13 wherein said timing mechanism comprises:
a planetary gear on a lower end of each said planetary screw, and
a ring gear associated with said drive nut, said planetary gears being in thread engagement with said ring gear.
